(19) United States
(12) Patent Application Publication
(10) Pub. No.: US 2016/0346966 A1
(43) Pub. Date: Dec. 1, 2016

(54) METHOD FOR PREPARING A FIBROUS MATERIAL PRE-IMPREGNATED WITH THERMOPLASTIC POLYMER WITH THE AID OF A SUPERCRITICAL GAS

(71) Applicant: ARKEMA FRANCE, Colombes (FR)

(72) Inventors: Patrice GAILLARD, Hagetaubin (FR); Gilles HOCHSTETTER, L'Hay-Les-Roses (FR); Thibaut SAVART, Lacanau de Mios (FR)

(73) Assignee: ARKEMA FRANCE, Colombes (FR)

(21) Appl. No.: 15/116,966

(22) PCT Filed: Feb. 11, 2015
(86) PCT No.: PCT/FR2015/050334

§ 371 Date: Aug. 5, 2016

(30) Foreign Application Priority Data
Feb. 13, 2014 (FR) 1451140

(51) Int. Cl. B29C 43/24; B29C 70/38; B29B 7/32; B29B 15/12; B29C 43/52

(52) U.S. Cl. CPC B29C 43/24; B29B 15/122; B29C 43/52; B29B 7/325; B29C 70/382; B29K 2067/006

(57) ABSTRACT

A method to produce a pre-impregnated fibrous material, in particular in ribbon form, including a fibrous reinforcement and thermoplastic polymer matrix, including a step of impregnating the fibrous material in the form of a single roving or several parallel rovings with the polymer in the molten state, the polymer in the molten state at the time of the impregnation containing a neutral gas in the supercritical state used as production aid by reducing viscosity in the molten state, preferably the gas being supercritical CO₂.

### FIELD OF THE INVENTION

The present invention concerns a method to prepare a pre-impregnated fibrous material, in particular in ribbon form, comprising a fibrous reinforcement and a thermoplastic polymer matrix.

The invention also concerns a pre-impregnated material, in particular in ribbon form and more particularly wound on a spool.

The invention also concerns the use of the method to produce calibrated ribbons suitable for manufacturing three-dimensional composite parts (3D) via automated fibre deposition of said ribbons and 3D composite parts, resulting from the utilisation of at least one pre-impregnated fibrous material particularly in ribbon form.

The production of pre-impregnated fibrous materials with a molten thermoplastic polymer or mixture of thermoplastic polymers, also called thermoplastic resin, allows the forming of these pre-impregnated fibrous materials into calibrated strips that can be used to manufacture composite materials. The pre-impregnated fibrous materials are used in the manufacture of structural parts with a view to obtaining lightweight parts whilst preserving mechanical strength comparable to that obtained with metal structural parts and/or ensuring the evacuation of electrostatic charges and/or ensuring thermal and/or chemical protection.

In the present description the term “strip” is used to designate strips of fibrous material having a width of 100 mm or larger. The term “ribbon” is used to designate ribbons of calibrated width of 100 mm or less.

Such pre-impregnated fibrous materials are intended in particular for the production of light composite materials to manufacture mechanical parts having a three-dimensional structure, good mechanical strength and thermal properties, capable of evacuating electrostatic charges i.e. properties compatible with the manufacture of parts particularly in the following sectors: mechanical, aeronautical, nautical, automobile, energy, construction (buildings), health and medical, military and armament, sports and leisure equipment and electronics. The composite materials are therefore used to manufacture three-dimensional (3D) parts, the manufacturer of these composite materials possibly using a method known as Automatic Fibre Placement (AFP) for example.

The composite materials obtained comprise the fibrous material formed of reinforcing fibres and a matrix formed of the impregnating polymer. The primary role of this matrix is to maintain the reinforcing fibres in compact form and to impart the desired shape to the end product. Said matrix acts inter alia to protect the reinforcing fibres against abrasion and harsh environments, to control surface appearance and to disperse any charges between the fibres. This matrix plays a major role in the long-term resistance of the composite material, in particular regarding fatigue and creep.

In the present invention, by “fibrous material” is meant an assembly of reinforcing fibres. Before being formed, it is in the form of rovings. After forming, it is in the form of strips or sheets or braids or in piece-form. If the reinforcing fibres are continuous, the assembly thereof forms a fabric. If the fibres are short, the assembly thereof forms a felt or nonwoven.

Those fibres able to be included in the composition of the fibrous material are more especially carbon fibres, glass fibres, basalt fibres, silicon carbide fibres (SIC), polymer-based fibres, plant fibres or cellulose fibres, used alone or in a mixture.

The good quality of the three-dimensional composite parts produced from pre-impregnated fibrous material demands control first over the impregnating method of the reinforcing fibre with thermoplastic polymer and secondly over the forming of the pre-impregnated fibrous material into a semi-finished product.

Up until the present time the production of strips of pre-impregnated fibrous materials, reinforced by impregnating with thermoplastic polymer could be obtained by means of several methods selected in particular in relation to the type of polymer, the type of desired end composite material and field of application. Powder deposit or molten polymer extrusion technologies are used to impregnate thermosetting polymers e.g. epoxy resins such as described in patent WO2012/066241A2. In general, these technologies cannot be applied directly to impregnation of thermoplastic polymers, in particular those with high melting temperature the viscosity of which in the molten state is too high to obtain good quality products.

Some companies market strips of fibrous materials obtained using a method to impregnate unidirectional fibres via continuous drawing of the fibres through a bath of molten thermoplastic polymer containing an organic solvent such as benzophenone. Reference can be made for example to document U.S. Pat. No. 4,541,884 by Imperial Chemical Industries. The presence of the organic solvent particularly allows adapting of the viscosity of the molten mixture and ensures good coating of the fibres. The fibres thus impregnated are then formed. For example they can be cut up into strips of different widths, placed under a press and heated to a temperature above the melting temperature of the polymer to ensure cohesion of the material and in particular adhesion of the polymer to the fibres. This impregnation and forming method allows structural parts to be obtained having high mechanical strength.

One of the disadvantages of this technique lies in the heating temperature required to obtain these materials. The melting temperature of the polymers is notably dependent upon their chemical nature. It may be relatively high for polymers of polymethyl methacrylate type (PMMA), even very high for polymers of polyphenylene sulfide (PPS), polyether ether ketone (PEEK) or polyether ketone ketone (PEKK) type for example. The heating temperature may therefore reach a temperature higher than 250° C., and even higher than 350° C., these temperatures being far higher than the boiling point and flash point of the solvent which are 305° C. and 150° C. respectively for benzophenone. In this case, sudden departure of the solvent is observed leading to high porosity within the fibre and thereby causing the onset of defects in the composite material. The method is therefore difficult to reproduce and involves risks of explosion placing operators in danger. Finally the use of organic solvents is to be avoided for environmental, hygiene and operator safety reasons.

Reference can be made to the closest state of the art formed by document WO2008/061170 (D1) to Honeywell International Inc. This document describes a method to prepare a fibre structure oriented unidirectionally. The utilisation of fibres of same type or of an assembly of fibres is envisaged (page 12, lines 25 to 29). However, in this method the fibres are arranged unidirectionally and are coated or impregnated by passing them through a bath containing a viscous liquid. This viscous liquid can be comprised of a thermoplastic resin for example for which viscosity is the most important parameter (page 14, lines 6 to 9). Immersion is followed by three steps: spreading, uniform coating and drying of the deposit to obtain the end product. The fibres of the arrangement therefore adhere to one another and form the desired structure. To obtain the desired viscosity, solvents are used if needed. The disadvantages of this technique are similar to the disadvantages described with the reference to the preceding technique, namely the use of solvent to reduce viscosity which, during melting of the polymer when the temperature is high, leads to sudden departure of the solvent inducing high porosity within the fibres and causing the onset of defects in the composite material. In addition, the use of organic solvents is to be avoided for environmental, hygiene and operator safety reasons.

With regard to the forming of pre-impregnated fibrous materials into calibrated ribbons adapted for the manufacture of three-dimensional composite parts by automated fibre placement, this is generally performed post-treatment.

The quality of ribbons in pre-impregnated fibrous material and hence the quality of the end composite material depends not only on the homogeneity of fibre impregnation, but also on the size and more particularly the width and thickness of the ribbons. Regularity and control over these two dimensional parameters would allow an improvement in the mechanical strength of the materials.

At the current time, irrespective of the method used to obtain fibrous material ribbons, the manufacture of ribbons of narrow width i.e. having a width of less than 100 mm generally requires slitting (i.e. cutting) of strips more than 500 mm wide also known as sheets. The ribbons thus cut to size are then taken up for depositing by a robotic head.

In addition, since the rolls of sheet do not exceed a length in the order of 1 km, the ribbons obtained after cutting are generally not sufficiently long to obtain some materials of large size produced by automated fibre deposition. The ribbons must therefore be stubbed to obtain a longer length, thereby creating over-thicknesses. These over-thicknesses lead to the onset of heterogeneities which are detrimental to obtaining composite materials of good quality.

Current techniques to impregnate fibrous materials and to form such pre-impregnated fibrous materials into calibrated ribbons therefore have several disadvantages. It is difficult for example to heat a molten mixture of thermoplastic polymers homogeneously inside a die, when it leaves the die and far as the core of the material, which deteriorates the quality of impregnation. In addition, the difference in temperature existing between the fibres and a molten mixture of polymers at the impregnating die also deteriorates the quality and homogeneity of impregnation. The use of organic solvents generally implies the onset of defects in the material and environmental and safety risks. The forming at post-treatment and at high temperature of the pre-impregnated fibrous material into strips remains difficult since it does not always allow homogenous distribution of the polymer within the fibres which leads to obtaining material of lesser quality. The slitting of sheet to obtain calibrated ribbons and stubbing of these ribbons give rise to additional production costs. Slitting also generates major dust problems which pollute the ribbons of pre-impregnated fibrous materials used for automated deposit and can lead to robot ill-functioning and/or imperfections in the composites. This potentially leads to robot repair costs, stoppage of production and discarding of non-conforming products. Finally, at the slitting step a non-negligible amount of fibres is deteriorated leading to loss of properties and in particular to a reduction in mechanical strength and conductivity of the ribbons in pre-impregnated fibrous material.

EP 2 664 643 belongs to the state of the art and describes a method to prepare a composite material comprising a continuous fibrous reinforcement (A′), a thermoplastic polymer of arylene polysulfide (B′), and a thermoplastic resin (C) bonded to said composite material. In particular, according to this document, said composite is prepared by impregnating said substrate (A′) with a dispersion or solution of a prepolymer of arylene polysulfide (B) in liquid phase, in an organic solvent that is inert against polymerisation of said prepolymer (B) (polymerisation in the presence of catalyst D) or E) which are compounds containing a specific transition metal or iron) or alternatively in a mineral solvent (CO₂, nitrogen or water) which may be in the supercritical state. First of all, the technical problem described in this document is not the same as that of the method of the present invention since, according to this document, the polymer (B′) used which is the final matrix of said composite is not used as such for impregnation of said fibrous substrate (A′) but instead its arylene polysulfide prepolymer precursor (B) in dispersion or in solution in said solvent. Therefore the technical function of said solvent is to disperse or to dissolve said arylene polysulfide prepolymer (B), precursor of polymer (B′), and it is neither described nor suggested in said document that said solvent compound is used to assist preparation by reducing the viscosity in the molten state of the final polymer as in the method of the present invention. In the method of the present invention, it is indeed this final polymer and matrix of said composite that is used for direct impregnation of said fibrous substrate assisted by said gas in the supercritical state. In the cited document the said solvent is used as polymerisation solvent of said prepolymer (B) to prepare said polymer (B′) having a longer chain. In the method of the present invention, the problem raised concerns a long chain thermoplastic polymer in the molten state, and does not concern a precursor prepolymer which does not give rise to the same problem for impregnation of said fibrous substrate. As a result, said method also differs in that said solvent is only used as solvent of said prepolymer (B) of low molecular weight and not of said polymer (B′) of higher molecular weight as is the case in the method of the present invention.

It is also possible to refer to the state of the art formed by the document Miller A et al: “Impregnation techniques for thermoplastic matrix composites”, POLYMERS AND POLYMER COMPOSITES, RAPRA TECHNOLOGIY, vol. 4, no 7, 1 Jan. 1996 (1996 Jan. 1, pages 459-481, XP000658227, ISSN:0967-3911. This document describes methods to impregnate a fibrous substrate with a thermoplastic resin, in particular via injection of said resin in the molten state (pages 461-462) and via dispersion of said resin in a solvent (pages 463-464). Some well-known disadvantages inherent in the use of such solvents and in the presence of residual solvents are listed on page 464, paragraph 1. At all events, this document does not concern the impregnation of a fibrous material with a polymer in the molten state containing a neutral gas in the supercritical state at the time of said impregnation.

### Technical Problem

It is therefore the objective of the invention to overcome at least one of the disadvantages of the prior art. In particular, the invention sets out to propose a method to prepare a pre-impregnated fibrous material, particularly in ribbon form, comprising a fibrous reinforcement and thermoplastic polymer matrix wherein impregnation is performed in the molten state of the polymer without any limitation as to the choice of thermoplastic polymer related to the melting temperature/viscosity of said polymer, and to obtain a pre-impregnated fibrous material having homogeneous fibre impregnation with controlled, reproducible porosity and dimensions.

### BRIEF DESCRIPTION OF THE INVENTION

For this purpose, the subject of the invention is a method to prepare a pre-impregnated fibrous material, in particular in ribbon form, comprising a fibrous reinforcement and thermoplastic polymer matrix, characterized in that it comprises the following step:
i) impregnating said fibrous material in the form of a single roving or several parallel rovings, with said polymer in the molten state, said polymer in the molten state at the time of said impregnation containing a neutral gas in the supercritical state used as preparation aid by reducing viscosity in the molten state, preferably said gas being supercritical CO₂.

Therefore, by using an agent to aid reduction in viscosity of the polymer in the molten state, by means of a neutral gas which may be a mixture of neutral gases in the supercritical state, the impregnation via molten route of a fibrous material in the form of a single roving or several parallel rovings with said polymer can be performed without any limitation as to the choice of thermoplastic polymer, and homogenous impregnation around the fibres is ensured with controlled, reproducible porosity and, in particular for “ready-to-use” prepegs, with a significant reduction in porosity reaching as far as no porosities.

Also, in addition to step i) the method comprises the following additional steps:
ii) forming said roving or said parallel rovings of said fibrous material impregnated at step i), by calendering using at least one heating calender, into the form of a single unidirectional ribbon or multiple parallel unidirectional ribbons, and in the latter case said heating calender comprising multiple calendering grooves, preferably up to 200 calendering grooves conforming to the number of said ribbons, the pressure and/or spacing between the rollers of said calender being regulated by a servo system.

Therefore, the method also allows the obtaining of one or more ribbons of long length and calibrated width and thickness, without having recourse to a slitting or stubbing step.

According to other optional characteristics of the method:

said polymer is a thermoplastic polymer or mixture of thermoplastic polymers;

said thermoplastic polymer or mixture of thermoplastic polymers further comprises carbon fillers, in particular carbon black or carbon nanofillers, preferably selected from among graphenes and/or carbon nanotubes and/or carbon nanofibrils or mixtures thereof;

the thermoplastic polymer or mixture of thermoplastic polymers further comprises liquid crystal polymers or cyclic polybutylene terephthalate, or mixtures containing the same, as additive;

said thermoplastic polymer, or mixture of thermoplastic polymers, is selected from among amorphous polymers having a glass transition temperature such that Tg≧80° C. and/or from among semi-crystalline polymers having a melting temperature Tf≧150° C.,

the thermoplastic polymer or mixture of thermoplastic polymers is selected from among: polyaryl ether ketones, in particular PEEK or polyaryl ether ketone ketones, in particular PEKK or aromatic polyether-imides (PEI) or polyaryl sulfones, in particular polyphenylene sulfones (PPS) or polyarylsulfides, in particular polyphenylene sulfides or among polyamides (PA), in particular aromatic polyamides optionally modified by urea units, or polyacrylates in particular polymethyl methacrylate (PMMA), or fluorinated polymers, in particular polyvinylidene fluoride (PVDF);

it further comprises a winding step iii) of said ribbon(s) onto one or more spools, the number of spools being identical to the number of ribbons, one spool being allocated to each ribbon;

the impregnation step i) is completed by a coating step of said single roving or said multiple parallel rovings after impregnation with the molten polymer at step i), with a molten polymer which may be the same or different from said impregnation polymer i), before said calendering step ii), preferably said molten polymer being the same as said impregnation polymer i), preferably said coating being performed via crosshead extrusion relative to said single roving or relative to said multiple parallel rovings;

said fibrous material comprises continuous fibres selected from among carbon, glass, silicon carbide, basalt, natural fibres in particular flax or hemp, sisal, silk or cellulose fibres in particular viscose, or thermoplastic fibres Tg higher than the Tg of said polymer or said mixture of polymers when the latter are amorphous, or has a Tf higher than the Tf of said polymer or said mixture of polymers when the latter are semi-crystalline, or a mixture of two or more of said fibres, preferably of carbon, glass or silicon carbide fibres, or mixture thereof, in particular carbon fibres;

according to an embodiment, the volume percentage of said polymer or mixture of polymers relative to said fibrous material varies from 40 to 250%, preferably from 45 to 125% and more preferably from 45 to 80%;

according to another embodiment, the volume percentage of said polymer or said mixture of polymers relative to said fibrous material varies from 0.2 to 15%, preferably between 0.2 and 10% and more preferably between 0.2 and 5%;

the calendering step ii) is performed using a plurality of heating calenders;

advantageously, said heating calender(s) at step ii) comprises an integrated heating system via induction or microwave, and preferably via microwave, combined with the presence of carbon fillers in said thermoplastic polymer or mixture of thermoplastic polymers;

advantageously, each heating calender is associated with a rapid heating device;

advantageously, said impregnation step is performed using an extrusion technique;

said impregnation technique is crosshead extrusion relative to said single roving or relative to said multiple parallel rovings;

said neutral gas in the supercritical state is a supercritical neutral gas or a mixture of supercritical neutral gases;

said neutral gas in the supercritical state is supercritical CO₂ gas or a mixture of neutral gases in the supercritical state containing CO₂ and a fluorinated gas or a CO₂ and nitrogen mixture;

said supercritical gas, preferably supercritical CO₂, is injected at the extrusion head;

said supercritical gas, preferably supercritical CO₂, is mixed with said molten impregnation polymer i) in a static mixer;

advantageously, the method comprises a step to heat the fibre rovings before the impregnation step i). The preferred heating means are microwave heating.

A further subject of the invention is a pre-impregnated material, in particular in ribbon form more particularly wound on a spool, chiefly characterized in that it is composed of a pre-impregnated fibrous material such as obtained using the previously defined method;

advantageously the pre-impregnated material is in the form of ribbon having a width and thickness adapted for depositing by a robot for the manufacture of 3D parts, without the need for slitting, and preferably having a width of at least 5 mm and possibly reaching 100 mm, more preferably 5 to 50 mm and further preferably 5 to 10 mm.

A further subject of the invention is the use of the method such as previously defined for the production of calibrated ribbons suitable for the manufacture of 3D composite parts via automated deposition of said ribbons by a robot;

the use of the pre-impregnated fibrous material, in particular in ribbon form, for the manufacture of 3D composite parts;

the use of the pre-impregnated fibrous material for the manufacture of said composite parts concerns the automobile, civil or military aviation, energy sectors in particular wind and hydrokinetic energy, energy storage devices, thermal protection panels, solar panels, ballistics for weapon and missile parts, safety, water sports and sailing, sports and leisure, building and construction or electronics.

The invention also relates to a three-dimensional (3D) composite part resulting from the use of at least one pre-impregnated fibrous material such as previously defined, in particular in ribbon form.

Finally the invention relates to a unit to implement the method to prepare a pre-impregnated fibrous material, in particular in ribbon form, such as defined above, said unit being chiefly characterized in that it comprises:

a) a device for continuous impregnation of a roving or plurality of parallel rovings of fibrous material comprising an impregnating die fed with polymer in the molten state containing the neutral gas in the supercritical state,

b) a device for continuous calendering of said roving or said parallel rovings, with forming into a single ribbon or into several parallel unidirectional ribbons, comprising:

b1) at least one heating calender, in particular several heating calenders in series, said calender having a calendering groove or several calendering grooves and preferably in this latter case having up to 200 calendering grooves;

b2) a servo system for regulating pressure and/or spacing between calender rollers.

Advantageously, the unit to implement the method comprises a heating device arranged before the impregnating device, said heating device being selected from among the following devices: a microwave or induction device, an infrared IR or laser device or other device allowing direct contact with the heat source such as flame device and preferably a microwave device.

### DESCRIPTION OF THE DRAWINGS

Other particular aspects and advantages of the invention will become apparent on reading the description that is non-limiting and given for illustrative purposes, with reference to the appended Figures illustrating:

FIG. 1, a schematic giving a side view of a unit to implement the method to produce a pre-impregnated fibrous material in calibrated ribbon form according to the invention,

FIG. 2, a schematic giving an overhead view of a unit to implement the method to produce a pre-impregnated fibrous material in calibrated ribbon form according to the invention,

FIG. 3, a cross-sectional schematic of two constituent rollers of a calender such as used in the unit in FIG. 1 or 2.

### DETAILED DESCRIPTION OF THE INVENTION

### Polymer Matrix

By thermoplastic or thermoplastic polymer is meant a material generally solid at ambient temperature, possibly being crystalline, semi-crystalline or amorphous, which softens on temperature increase, in particular after passing its glass transition temperature (Tg) if it is amorphous, flows at higher temperature and may melt without any phase change when it passes its melting temperature (Tf) if it is crystalline or semi-crystalline, and it returns to the solid state when the temperature drops to below its melting temperature and below its glass transition temperature.

Regarding the constituent polymer of the impregnation matrix of the fibrous material in the present invention, this polymer is advantageously a thermoplastic polymer or mixture of thermoplastic polymers. The thermoplastic polymer or polymer mixture is fed into an impregnation die connected to a polymer extrusion system capable of extruding the thermoplastic polymer or mixture of thermoplastic polymers in the molten state in the presence of the neutral gas in the supercritical state, which may be a mixture of neutral gases in the supercritical state.

Optionally, the thermoplastic polymer or mixture of thermoplastic polymers further comprises carbon fillers, carbon black in particular or carbon nanofillers, preferably selected from among carbon nanofillers in particular graphenes and/or carbon nanotubes and/or carbon nanofibrils or the mixtures thereof. These fillers allow conducting of electricity and heat and therefore allow improved lubrication of the polymer matrix when it is heated.

According to another variant, the thermoplastic polymer or mixture of thermoplastic polymers may further comprise additives such a liquid crystal polymers or cyclic polybutylene terephthalate, or mixtures containing the same such as CBT100 resin marketed by CYCLICS CORPORATION. These additives particularly allow fluidisation of the polymer matrix in the molten state, for better penetration into the core of the fibres. Depending on the type of thermoplastic polymer or polymer mixture used to prepare the impregnation matrix, in particular the melting temperature thereof, one or other of these additives will be chosen.

Advantageously, the thermoplastic polymer, or mixture of thermoplastic polymers, is selected from among amorphous polymers having a glass transition temperature such that Tg≧80° C. and/or from among semi-crystalline polymers having a melting temperature Tf≧150° C.

More particularly, the thermoplastic polymers entering into the composition of the fibrous material impregnation matrix can be selected from among:

polymers and copolymers of the polyamide family (PA), such as high density polyamide, polyamide 6 (PA-6), polyamide 11 (PA-11), polyamide 12 (PA-12), polyamide 6.6 (PA-6.6), polyamide 4.6 (PA-4.6), polyamide 6.10 (PA-6.10), polyamide 6.12 (PA-6.12), aromatic polyamides, optionally modified by urea units, in particular polyphthalamides and aramid, and block copolymers in particular polyamide/polyether,

polyureas, aromatic in particular,

polymers and copolymers of the acrylic family such as polyacrylates, and more particularly polymethyl methacrylate (PMMA) or the derivatives thereof,

polymers and copolymers of the polyarylether ketone family (PAEK) such as polyether ether ketone (PEEK), or polyarylether ketone ketones (PAEKK) such as polyether ketone ketone) (PEKK) or the derivatives thereof,

aromatic polyether-imides (PEI),

polyarylsulfides, in particular polyphenylene sulfide (PPS),

polyarylsulfones, in particular polyphenylene sulfones (PPSU),

polyolefins, in particular polyethylene (PE);

polylactic acid (PLA),

polyvinyl alcohol (PVA),

fluorinated polymers, in particular polyvinylidene fluoride (PVDF), or polytetrafluoroethylene (PTFE) or polychlorotrifluoroethylene (PCTFE),

and the mixtures thereof.

Preferably the constituent polymers of the matrix are selected from among thermoplastic polymers having a high melting temperature Tf, namely on and after 150° C., such as Polyamides (PA), in particular aromatic polyamides optionally modified by urea units and the copolymers thereof, Polymethyl methacrylate (PPMA) and the copolymers thereof, Polyether imides (PEI), Polyphenylene sulfide (PPS), Polyphenylene sulfone (PPSU), Polyetherketoneketone (PEKK), Polyetheretherketone (PEEK), fluorinated polymers such as polyvinylidene fluoride (PVDF).

And further preferably, the thermoplastic polymer or mixture of thermoplastic polymers is selected from among polyaryl ether ketones in particular PEEK, or polyaryl ether ketone ketones in particular PEKK, or aromatic polyether-imides (PEI) or polyaryl sulfones in particular polyphenylene sulfones (PPS), or polyarylsulfides in particular polyphenylene sulfides, or from among polyamides (PA) in particular aromatic polyamides optionally modified by urea units, or polyacrylates in particular polymethyl methacrylate (PMMA), or fluorinated polymers in particular polyvinylidene fluoride (PVDF).

For fluorinated polymers, a homopolymer of vinylidene fluoride (VDF of formula CH₂═CF₂) is preferred, or a VDF copolymer comprising at least 50 weight % VDF and at least one other monomer copolymerisable with VDF. The VDF content must be higher than 80 weight %, even better higher than 90 weight % to impart good mechanical strength to the structural part, especially when subjected to thermal stresses. The comonomer may be a fluorinated monomer selected from among vinyl fluoride for example.

For structural parts that are to withstand high temperatures, in addition to fluorinated polymers advantageous use can be made according to the invention of PAEKs (PolyArylEtherKetone) such as polyether ketones (PEK), polyether ether ketone (PEEK), polyether ketone ketone (PEKK), polyether ketone ether ketone ketone (PEKEKK), etc.

### Fibrous Material:

Regarding the constituent fibres of the fibrous material, these are fibres of mineral, organic or plant origin in particular such as carbon, glass, silicon carbide, basalt fibres, natural fibres in particular flax or hemp, sisal, silk or cellulose in particular viscose, or thermoplastic fibres having a Tg higher than the Tg of said polymer or said mixture of polymers when these are amorphous, or having a Tf higher than the Tf of said polymer or said mixture of polymers if these are semi-crystalline, or a mixture of two or more of said fibres, preferably carbon, glass or silicon carbide fibres or a mixture thereof, in particular carbon fibres.

Among the fibres of mineral origin, one can choose carbon fibres, glass fibres, basalt fibres, silica fibres or silicon carbide fibres for example. Among the fibres of organic origin, one can choose fibres containing a thermoplastic or thermosetting polymer such as aromatic polyamide fibres, aramid fibres or polyolefin fibres for example. Preferably they are thermoplastic polymer-based and have a glass transition temperature Tg higher than the Tg of the constituent thermoplastic polymer or thermoplastic polymer mixture of the impregnation matrix if the polymer(s) are amorphous, or a melting temperature Tf higher than the Tf of the constituent thermoplastic polymer or thermoplastic polymer mixture of the impregnation matrix if the polymer(s) are semi-crystalline. There is therefore no risk of melting of the constituent organic fibres of the fibrous material. Among the fibres of plant origin, one can choose natural flax, hemp, silk in particularly spider silk, sisal fibres and other cellulose fibres particularly viscose. These fibres of plant origin can be used pure, treated or coated with a coating layer to facilitate adhesion and impregnation of the thermoplastic polymer matrix.

The fibres constituting the fibrous material can be used alone or in a mixture. For example, organic fibres can be mixed with mineral fibres for impregnation with thermoplastic polymer and to form the pre-impregnated fibrous material.

The chosen fibres can be single-strand, multi-strand or a mixture of both, and can have several gram weights. In addition they may have several geometries. They may therefore be in the form of short fibres, then producing felts or nonwovens in the form of strips, sheets, braids, rovings or pieces, or in the form of continuous fibres producing 2D fabrics, fibres or rovings of unidirectional fibres (UD) or nonwovens. The constituent fibres of the fibrous material may also be in the form of a mixture of these reinforcing fibres having different geometries. Preferably, the fibres are continuous.

Preferably, the fibrous material is composed of continuous fibres of carbon, glass or silicon carbide or a mixture thereof, in particular carbon fibres. It is used in the form of roving(s).

Depending on the volume ratio of polymer relative to the fibrous material, it is possible to produce so-called “ready-to-use” pre-impregnated materials or so-called “dry” pre-impregnated materials.

In so-called “ready-to-use” pre-impregnated materials, the thermoplastic polymer or polymer mixture is uniformly and homogeneously distributed around the fibres. In this type of material, the impregnating thermoplastic polymer must be distributed as homogenously as possible within the fibres to obtain minimum porosities i.e. voids between the fibres. The presence of porosities in this type of material may act as stress-concentrating points when subjected to a mechanical tensile stress for example and then form rupture initiation points in the pre-impregnated fibrous material causing mechanical weakening. Homogeneous distribution of the polymer or polymer mixture therefore improves the mechanical strength and homogeneity of the composite material produced from these pre-impregnated fibrous materials.

Therefore, with regard to so-called “ready-to-use” pre-impregnated materials, the volume percentage of thermoplastic polymer or polymer mixture relative to the fibrous material varies from 40 to 250%, preferably from 45 to 125%, and more preferably from 45 to 80%.

So-called “dry” pre-impregnated fibrous materials comprise porosities between the fibres and a smaller amount of impregnating thermoplastic polymer coating the fibres on the surface to hold them together. These “dry” pre-impregnated materials are adapted for the manufacture of preforms for composite materials. These pre-forms can then be used for the infusion of thermoplastic resin or thermosetting resin for example. In this case, the porosities facilitate subsequent conveying of the infused polymer into the pre-impregnated fibrous material, to improve the end properties of the composite material and in particular the mechanical cohesion thereof. In this case, the presence of the impregnating thermoplastic polymer on the so-called “dry” fibrous material is conducive to compatibility of the infusion resin.

With regard to so-called “dry” pre-impregnated materials therefore, the volume percentage of polymer or mixture of polymers relative to the fibrous material advantageously varies from 0.2 to 15%, preferably between 0.2 and 10% and more preferably between 0.2 and 5%. In this case the term polymeric web is used having low gram weight, deposited on the fibrous material to hold the fibres together.

### Impregnation Step:

The method to prepare a pre-impregnated fibrous material, in particular in ribbon form, according to the invention, is carried out using a device for the continuous impregnation of a roving or plurality of parallel rovings of fibrous material, advantageously comprising an impregnating die fed with polymer in the molten state containing the neutral gas in the supercritical state.

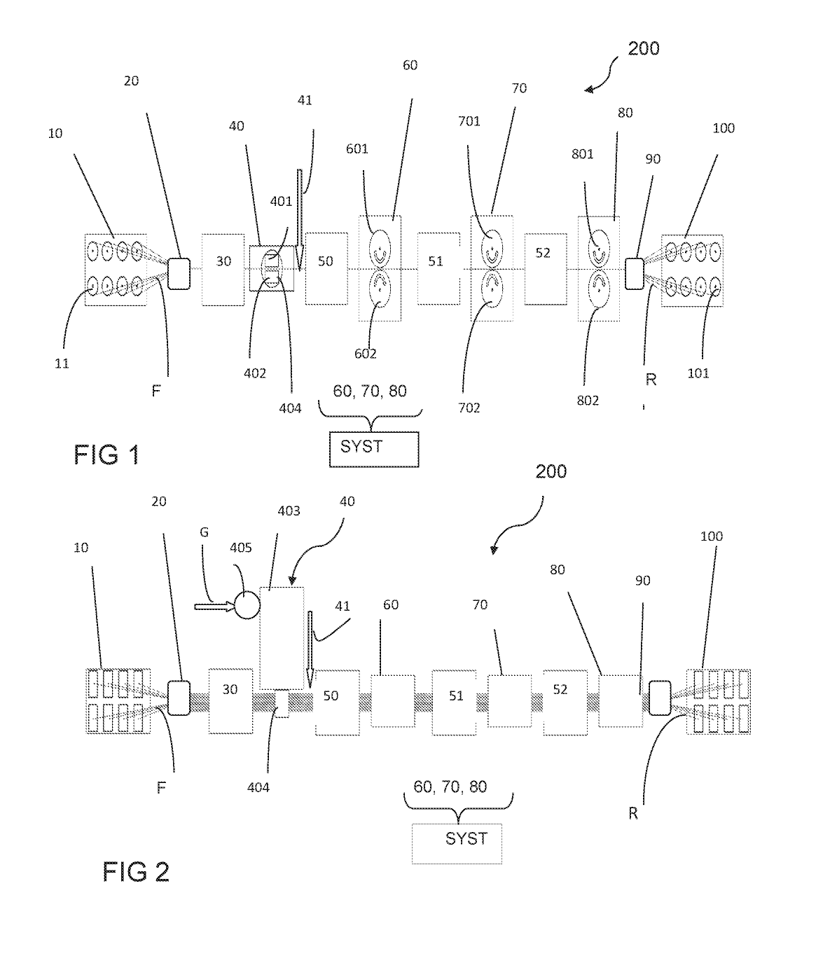

The method and unit to implement this method are described below in connection with FIGS. 1 and 2 giving a very simple schematic of the constituent elements of this unit 200.

Advantageously, the impregnation step of the fibrous material is performed using an extrusion technique. More particularly, it is crosshead extrusion relative to the single roving or relative to the multiple parallel rovings.

Advantageously, impregnation is obtained by passing one or more rovings F through a continuous impregnating device 40, this impregnating device 40 comprising an impregnation head 404, also called an impregnation die.

Each roving to be impregnated is unwound by means of a reel 11 device 10, under traction generated by cylinders (the axes thereof being illustrated). Preferably the device 10 comprise a plurality of reels 11, each reel allowing the unwinding of one roving to be impregnated. It is therefore possible to impregnate several fibre rovings simultaneously. Each reel 11 is provide with a braking system (not illustrated) to tension each fibre roving. In this case an alignment module 20 allows the fibre rovings to be arranged parallel to one another. In this manner the fibre rovings cannot come into contact with each other, thereby particularly avoiding mechanical degradation of the fibres.

Optionally, impregnation can be completed by a step to coat said single roving or said multiple parallel rovings after impregnation with the molten polymer, with a molten polymer which may be the same or different from said impregnation polymer, before the calendering step. Preferably the molten polymer is the same as the impregnation polymer and preferably coating is carried out by crosshead extrusion relative to the single roving or relative to said multiple parallel rovings. The use of a different polymer may allow the imparting of additional properties to the composite material obtained or may improve the properties thereof as compared with the properties provided by the impregnation polymer. The crosshead is fed with molten thermoplastic polymer by an extruder, this assembly being symbolised by the arrow 41 in FIGS. 1 and 2. Such coating effectively not only allows completion of the fibre impregnation step to obtain a final volume percentage of polymer within the desired range, in particular to obtain so-called “ready-to-use” fibrous materials of good quality, but also allows improvement in the performance of the composite material obtained.

Before being passed through the impregnation head 404, the fibre roving or parallel fibre rovings are passed through a heating device 30 having controlled, variable temperature, ranging from ambient temperature up to 1000° C. However, this temperature is to be reduced for organic polymers which would fully degrade at around 500° C., and must remain with the temperature limits not to be exceeded for impregnation. The heating temperature must not exceed 250° C. in this case. This heating allows the fibre rovings to be brought to a temperature facilitating the impregnation thereof without however minimising the technical effect contributed by the supercritical gas mixed with the molten polymer, namely reduced viscosity. This prior heating effectively prevents the polymer from recrystallizing too rapidly through contact with the rovings. The heating device 30 can also allow initiated polymerisation of a material previously deposited on the fibre rovings, or can modify even degrade, even fully degrade, fibre sizing via thermal route. Sizing corresponds to the small amount of polymer generally coating the fibre rovings to ensure binding between these fibres within the roving, but also compatibility with the polymer matrix for a resin infusion method for example. This heating device 30 can be selected for example from among the following devices: a microwave or induction device, infrared IR or laser device or other device allowing direct contact with the heat source such as a flame device. A microwave or induction device is most advantageous, in particular when combined with the presence of carbon nanofillers in the polymer or mixture of polymers since carbon nanofillers amplify the heating effect and convey this effect into the core of the material.

On leaving this heating device 30, the different fibre rovings are passed through the impregnation head 404. This impregnation head is composed of an upper part 401 and lower part 402 allowing adjustment of the die opening at the fibre roving input and output. The impregnation head 404 is connected to a polymer extrusion device 403 of worm-screw type capable of extruding the polymer of mixture of polymers in the molten state, the polymer therefore being at high temperature and in the presence of a supercritical gas or gas mixture G.

Advantageously, the polymer extrusion device is composed of a single-screw extruder 403 comprising degassing zones (not illustrated). This extruder is preferably connected to a static mixer 405 itself connected to a gear pump (not illustrated) ensuring feeding of polymer into the die at a constant rate.

To prevent rising of the supercritical gas up into the feed hopper (not illustrated), the supercritical gas G is injected preferably at a distance away from the feed hopper, and the extrusion parameters are adapted so that a sufficient amount of viscous polymer is present between the gas inlet and the feed hopper and prevents the gas from rising up towards the hopper, preferably said gas being injected into a controlled zone of said static mixer under regulated low pressure.

On leaving the impregnation device the pre-impregnated roving(s) are directed towards a calendering device.

### Supercritical Neutral Gas

By supercritical neutral gas is meant a substance brought to a temperature and pressure higher than the critical temperature and pressure thereof, a domain in which no distinction can be made between gaseous and liquid phases. The properties of a supercritical neutral gas are intermediate between those of a gas and those of a liquid. The terms supercritical gas or fluid are used indifferently.

In the present invention, the neutral gas in supercritical state is a supercritical neutral gas or mixture of supercritical neutral gases.

Advantageously, among supercritical gases, those selected may be carbon dioxide, ethane, propane, pentane, water, methanol, ethanol, nitrogen for example, or mixtures of these supercritical gases.

More particularly, preferable use is made of supercritical carbon dioxide (hereafter designated CO₂sc), or mixtures of supercritical gases containing CO₂sc to fluidise the thermoplastic polymers and facilitate impregnation therewith or, for the production of dry rovings, to obtain foaming.

Advantageously the neutral gas in the supercritical state is supercritical CO₂ or a mixture of neutral gases in the supercritical state containing CO₂ and a fluorinated gas. According to one option, the mixture contains CO₂ and nitrogen.

The supercritical gas G, preferably supercritical CO₂, is injected at the extrusion head 403. Preferably the supercritical gas, preferably supercritical CO₂ is mixed with said molten impregnating polymer at step i) of the method, in a static mixer 405 in particular under regulated reduced pressure in said mixer.

### Forming Step

Immediately on leaving the impregnating device 40, and optionally the coating device 41, the roving (parallel rovings) pre-impregnated with a molten polymer are formed into a single unidirectional ribbon or into a plurality of parallel unidirectional ribbons B, by means of a continuous calendering device comprising one or more heating calenders.

In prior art techniques, hot calendering could not be envisaged for a forming step but only for a finishing step since it was not able to heat up to sufficient temperatures, in particular if the thermoplastic polymer or polymer mixture comprises polymers with a high melting temperature.

Advantageously, this hot calendering not only allows the impregnation polymer to be heated so that it penetrates into, adheres to and uniformly coats the fibres, but also provides control over the thickness and width of the ribbons of pre-impregnated fibrous material and in particular the porosity thereof.

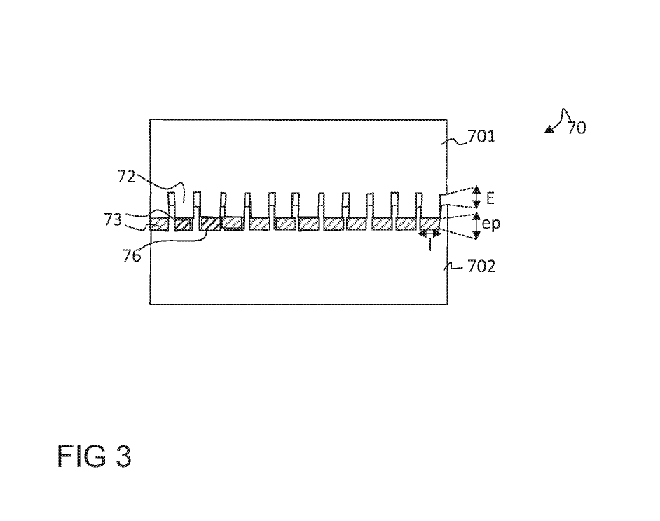

To produce a plurality of parallel unidirectional ribbons i.e. as many ribbons as parallel rovings pre-impregnated with the impregnating device 40, optionally coated by the coating device 41, the heating calenders referenced 60, 70, 80 in the schematic in FIG. 1 advantageously comprise a plurality of calendering grooves conforming to the number of ribbons. This number of grooves may total up to 200 for example. A SYST servo system allows regulation of the pressure and/or of the spacing E between the rollers (601, 602); (701, 702) and (801, 802) of the calenders. As an example, FIG. 3 illustrates details of the calender 70. In this FIG. 3 the rollers 701, 702 of the calender 70 can be seen, regulation of the pressure and/or spacing E being carried out to control the thickness ep of the ribbons via a servo system SYST driven by a computer programme provide for this purpose.

The calendering device comprises at least one heating calender 60. Preferably it comprises several heating calenders 60, 70, 80 mounted in series. The fact that there are several calenders in series means that it is possible to compress the porosities and reduce the number thereof. This plurality of calenders is therefore of importance if it is desired to produce so-called “ready-to-use” fibrous materials. On the other hand, to produce so-called “dry” fibrous materials, a fewer number of calenders will be sufficient, even a single calender.

Advantageously, each calender of the calendering device has an integrated heating system via induction or microwave and preferably microwave, to heat the thermoplastic polymer or polymer mixture. Advantageously if the polymer of polymer mixture comprises carbon fillers such as carbon black or carbon nanofillers, preferably selected from among carbon nanofillers in particular graphenes and/or carbon nanotubes and/or carbon nanofibrils or the mixtures thereof, the heating effect via induction is amplified by these fillers which then convey the heat into the core of the material.

Advantageously, the heating calenders of the heating device are coupled to a rapid heating device 50, 51, 52 allowing the material to be heated not only on the surface but also at the core. The mechanical loading of the calenders coupled with these rapid heating devices first provides control over porosities and more particularly reduces these to a minimum going as far as eliminating the presence of porosities, and secondly obtains homogeneous distribution of the polymer, in particular when the pre-impregnated fibrous material is a so-called “ready-to-use” material. These rapid heating devices are positioned before and/or after each calender for rapid transmission of thermal energy to the material. The rapid heating device can be selected for example from among the following devices: a microwave or induction device, an infrared IR or laser device or other device allowing direct contact with a heat source such as a flame device. A microwave or induction device is most advantageous, in particular when combined with the presence of carbon nanofillers in the polymer or polymer mixture since carbon nanofillers amplify the heating effect and transmit this effect to the core of the material.

According to one variant of embodiment it is also possible to combine several of these heating devices.

In the example of embodiment, each 60, 70, 80 of the calendering device is coupled to a rapid heating device 50, 51, 52.

Optionally, a subsequent step is to spool the pre-impregnated, formed ribbon(s). For this purpose a unit 200 to implement the method comprises a spooling device 100 comprising as many spools 101 as there are ribbons, one spool 101 being allocated to each ribbon. A distributor 90 is generally provided to direct the pre-impregnated ribbons towards their respective spool 101 whilst preventing the ribbons from touching one another to prevent any degradation.

FIG. 3 schematises details of the groove 73 of a calender, the calender 70 in cross-section in the example. The calender 70 comprises an upper roller 701 and a lower roller 702. One of the rollers e.g. the upper roller 701 comprises a castellated part 72, whilst the other roller i.e. the lower roller 702 in the example comprises a grooved part 76, the shape of the grooves matching the protruding parts 72 of the upper roller. The spacing E between the rollers 701, 75 and/or the pressure applied by the two rollers against one another allows defining of the dimensions of the grooves 73, and in particular the thickness ep thereof and width I. Each groove 73 is designed to house a fibre roving which is then pressed and heated between the rollers. The rovings are subsequently transformed into parallel unidirectional ribbons, the dimensions, thickness and width of which are calibrated precisely by the grooves 73 of the calenders. Each calender advantageously comprises a plurality of grooves the number of which may total up to 200, so that as many ribbons can be produced as there are grooves and pre-impregnated rovings. The calendering device also comprises the servo system SYST allowing simultaneous regulation of the pressure and/or spacing between the calender rollers of all the calenders in the unit 200.

The unidirectional ribbon(s) thus produced have a width I and thickness ep adapted for depositing by a robot for the manufacture of three-dimensional parts without the need for slitting. The width of the ribbon(s) is advantageously between 5 and 100 mm, preferably between 5 and 50 mm, and more preferably between 5 and 10 mm.

The method of producing a pre-impregnated fibrous material just described therefore allows pre-impregnated fibrous materials to be produced with high productivity whilst allowing homogeneous impregnation of the fibres, providing control over porosity which is reproducible and hence providing controlled, reproducible performance of the targeted end composite product. Homogeneous impregnation around the fibres and the absence of porosities are ensured by the impregnation step by means of the polymer in the molten state containing a neutral gas or mixture of neutral gases in the supercritical state which assists production by reducing the viscosity of said polymer in the molten state, and through the use of a forming device under mechanical loading (heating calender), itself coupled to rapid heating devices, thereby allowing heating of the material on the surface as well as at the core. The materials obtained are semi-finished products in the form of ribbons with calibrated thickness and width used for the manufacture of three-dimensional structural parts in transport sectors such as automobile, civil or military aviation, nautical, rail, renewable energies, sports and leisure equipment, health and medicine, weapons and missiles, safety and electronics—using a method entailing the deposition assisted by a robot head for example and known as Automatic Fibre Placement (AFP).

This method therefore allows the continuous manufacture of ribbons of calibrated size and long length, with the result that it avoids slitting and stubbing steps that are costly and detrimental to the quality of subsequently manufactured composite parts. The savings related to elimination of the slitting step represent about 30-40% of the total production cost of a ribbon of pre-impregnated fibrous material.

The association of rapid heating devices with the heating calenders facilitates forming of the ribbons to the desired dimensions, and allows a significant increase in the production rate of these ribbons compared with conventional forming methods. In addition this association allows densification of the material by fully eliminating the porosities in so-called “ready-to-use” fibrous materials.

The rapid heating devices also allow the use of numerous grades of polymers, even the most viscous, thereby covering all the desired ranges of mechanical strength.

For the specific manufacture of ribbons of so-called “dry” fibrous materials, the impregnation step with a polymer in the molten state containing a supercritical neutral gas allows a polymer gram weight to be obtained that is homogenously distributed, with a preferred content of deposited polymer in the order of 5 to 7 g/m, and allows the obtaining of good penetration of resins used for infusion on preforms for example.

1. A method for preparing a pre-impregnated fibrous material, the pre-impregnated fibrous material comprising a fibrous reinforcement and thermoplastic polymer matrix, wherein the method comprises the following step:
i) impregnating said fibrous material in the form of a single roving or several parallel rovings with a polymer in the molten state, said polymer in the molten state at the time of said impregnation containing a neutral gas in the supercritical state used as preparation aid by reducing viscosity in the molten state.

2. The method according to claim 1, wherein said polymer is a thermoplastic polymer or mixture of thermoplastic polymers.

3. The method according to claim 2, wherein said thermoplastic polymer or mixture of thermoplastic polymers further comprises carbon fillers.

4. The method according to claim 2, wherein the thermoplastic polymer or mixture of thermoplastic polymers further comprises liquid crystal polymers or cyclic polybutylene terephthalate, or mixtures containing the same, as additive.

5. The method according to claim 2, wherein said thermoplastic polymer, or mixture of thermoplastic polymers, is selected from among amorphous polymers having a glass transition temperature such that Tg≧80° C. and/or from among semi-crystalline polymers having a melting temperature Tf≧150° C.

6. The method according to claim 5, wherein the thermoplastic polymer or mixture of thermoplastic polymers is selected from among: polyaryl ether ketones, aromatic polyether-imides (PEI), polyaryl sulfones, polyarylsulfides, among polyamides (PA), polyacrylates, or fluorinated polymers.

7. The method according to claim 1, wherein in addition to step i) it comprises the following additional steps:
ii) forming said roving or said parallel rovings of said fibrous material impregnated at step i), by calendering using at least one heating calender into the form of a single unidirectional ribbon or multiple parallel unidirectional ribbons, in the latter case said heating calender comprising multiple calendering grooves, the pressure and/or spacing between the rollers of said calender being regulated by a servo system.

8. The method according to claim 7, wherein the method further comprises a winding step iii) of said ribbon(s) onto one or more spools, the number of spools being identical to the number of ribbons, one spool being allocated to each ribbon.

9. The method according to claim 1, wherein said impregnation step i) is completed by a coating step of said single roving or said multiple parallel rovings after impregnation with the molten polymer at step i), with a molten polymer which may be the same or different from said impregnation polymer i), before said calendering step ii).

10. The method according to claim 1, wherein said fibrous material comprises continuous fibres selected from among carbon, glass, silicon carbide, basalt, natural fibres, or thermoplastic fibres having Tg higher than the Tg of said polymer or said mixture of polymers when the latter are amorphous or having Tf higher than the Tf of said polymer or said mixture of polymers when the latter are semi-crystalline, or a mixture of two or more of said fibres.

11. The method according to claim 2, wherein the volume percentage of said polymer or mixture of polymers relative to said fibrous material varies from 40 to 250%.

12. The method according to claim 2, wherein the volume percentage of said polymer or said mixture of polymers relative to said fibrous material varies from 0.2 to 15%.

13. The method according to claim 7, wherein the calendering step ii) is performed using a plurality of heating calenders.

14. The method according to claim 7, wherein said heating calender(s) at step ii) comprise an integrated heating system via induction or microwave, combined with the presence of carbon fillers in said thermoplastic polymer or mixture of thermoplastic polymers.

15. The method according to claim 13, wherein each heating calender is associated with a rapid heating device.

16. The method according to claim 1, wherein said impregnation step is performed using an extrusion technique.

17. The method according to claim 16, wherein said impregnation technique is crosshead extrusion relative to said single roving or relative to said multiple parallel rovings.

18. The method according to claim 1, wherein said neutral gas in the supercritical state is a supercritical neutral gas or a mixture of supercritical neutral gases.

19. The method according to claim 17, wherein said neutral gas in the supercritical state is supercritical CO₂ gas or a mixture of neutral gases in the supercritical state containing CO₂ and a fluorinated gas or a CO₂ and nitrogen mixture.

20. The method according to claim 1, wherein said supercritical gas is injected at the extrusion head.

21. The method according to claim 1, wherein said supercritical gas is mixed with said molten impregnating polymer i) in a static mixer.

22. A pre-impregnated material, wherein the material is made from a pre-impregnated fibrous material obtained using a method as defined in claim 1.

23. The pre-impregnated material according to claim 22, wherein the material is in the form of ribbon having a width and thickness adapted for depositing by a robot for the manufacture of 3D parts, without the need for slitting.

24. A method for the production of calibrated ribbons suitable for the manufacture of 3D composite parts via automated deposition of said ribbons by a robot, wherein the ribbons are formed by the method of claim 1.

25. A method of manufacturing 3D composite parts comprising manufacturing 3D composite parts from the pre-impregnated fibrous material defined in claim 22.

26. The method according to claim 24, wherein said manufacture of said composite parts concerns the automobile, civil or military aviation, energy storage devices, thermal protection panels, solar panels, ballistics for weapon and missile parts, safety, water sports and sailing, sports and leisure, building and construction or electronics.

27. A 3D composite part resulting from utilisation of at least one pre-impregnated fibrous material defined in claim 22.

28. A unit to implement the method for preparing a pre-impregnated fibrous material as defined in claim 1, wherein said unit comprises:
a) a device for continuous impregnation of a roving or plurality of parallel rovings, comprising an impregnation die fed with polymer in the molten state containing the neutral gas in the supercritical state,
b) a device for continuous calendering of said roving or said parallel rovings, with forming into a single ribbon or into several parallel unidirectional ribbons, comprising:
b1) at least one heating calender, said calender having a calendering groove or several calendering grooves,
b2) a servo system for regulating pressure and/or spacing between the calender rollers.

29. The unit to implement the method according to claim 28, wherein the unit comprises a heating device arranged before the impregnation device and selected from among the following devices: a microwave or induction device, an infrared IR or laser device or other device allowing direct contact with the heat source.
